(19) United States
(12) Patent Application Publication
(10) Pub. No.: US 2017/0178503 A1
(43) Pub. Date: Jun. 22, 2017

(54) SYSTEM FOR PREEMPTING THE NORMAL FUNCTION OF TRAFFIC SIGNALS

(71) Applicant: Dave Gross, Fort Wayne, IN (US)

(72) Inventor: Dave Gross, Fort Wayne, IN (US)

(21) Appl. No.: 14/976,607

(22) Filed: Dec. 21, 2015

(51) Int. Cl. G08G 1/087

(52) U.S. Cl. CPC G08G 1/087

(57) ABSTRACT

A traffic preemption system including at least one of a vehicle and a driver identification means; a historical travel database; and a traffic signal preemption means. The traffic signal preemption means is configured to preempt the normal action of traffic signals dependent upon the vehicle and/or the driver identified by the identification means and historical routes taken by the vehicle and/or the driver as determined in the historical travel database.

### BACKGROUND OF THE INVENTION

1. Field of the Invention

The present invention generally relates to traffic control systems, and more particularly to, a signal preemption system that prioritizes traffic signal changes to efficiently route an emergency vehicle.

2. Description of the Related Art

Emergency vehicles, such as fire-fighting engines, ambulances and police cars, generally have the need to cross or pass intersections under the control of traffic signals. This must be accomplished in the least amount of time possible so that the function of an emergency vehicle can be successfully fulfilled. It is generally understood that the more quickly an emergency vehicle can reach the scene of an emergency, the greater are the chances that the victims involved can be helped or successfully treated.

Since the earliest times, emergency vehicles approaching intersections have depended upon sirens, horns, bells or other types of audible and/or visible warning devices to alert other people in the intersection. This has not always proven to be a successful technique, even though it is still the standard mode of operation for emergency vehicles today. Unfortunately, accidents involving emergency vehicles often occur at intersections due to confusion, impaired hearing, inattention, noise conditions or overly-aggressive drivers seeking to clear the intersection before the arrival of the emergency vehicle. Other factors are the speed of the emergency vehicle and the resulting inability of others to react to it, distractions affecting the driver of the emergency vehicle, and the like. Further problems are caused when multiple emergency vehicles are approaching the same intersection. This situation is further complicated when the sirens and other signals from multiple emergency vehicles can be heard within the same area—a combination confusing to both pedestrians and other motorists, as well as the operators of both emergency vehicles. In many cases, due to siren noise and the intensity of focused driving at high speeds through congested areas, emergency vehicle operators are often not aware of other such vehicles in the same area.

During the course of emergency vehicles which are preempting traffic signals enroute to the scene, emergency vehicle drivers can often forget to use their turn signals. If a preemption-equipped emergency vehicle is about to make a left turn, for example, traffic signals to the left of the intersection will not begin their preemption sequence until after the left turn has been made. This may not allow for ample time for the next traffic signal in its path (following the turn) to effectively clear traffic along the route, slowing its response.

What is needed in the art is a system that can predictively preempt the normal operation of traffic signals.

### SUMMARY OF THE INVENTION

The present invention provides a system and method of preempting a normal operation of traffic signals.

The invention in one form is directed to a traffic preemption system including at least one of a vehicle and a driver identification means; a historical travel database; and a traffic signal preemption means. The traffic signal preemption means is configured to preempt the normal action of traffic signals dependent upon the vehicle and/or the driver identified by the identification means and historical routes taken by the vehicle and/or the driver as determined in the historical travel database.

The invention in another form is directed to a method of preempting traffic signals including the steps of: identifying at least one of a vehicle and an operator of the vehicle; comparing a situation of at least one of the identified vehicle and the identified operator with previous travel patterns of the at least one of the identified vehicle and the identified operator; predicting at least one likely travel path of the vehicle dependent upon the results of the comparing step; and preempting a normal operation of traffic signals along the at least one likely travel path of the vehicle.

An advantage of the traffic preemption system of the present invention is that it looks at historical traffic patterns to help clear traffic from a likely route.

Another advantage is that the traffic preemption system allows the function of the turn signal to override the predicted path.

Yet another advantage is that the system uses the habits of drivers to determine the likely travel path.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a perspective view of a traffic intersection where an embodiment of a traffic signal preemption system of the present invention is functioning;

FIG. 2 is a generic top view of a series of streets that have the traffic signal preemption system of FIG. 1 installed therein, with this figure being used to discuss the system;

FIG. 3 is a top view of a series of streets that have the traffic signal preemption system of FIG. 1 installed therein, with this figure also being used to discuss the system;

FIG. 4 is also a top view of a series of streets that have the traffic signal preemption system of FIG. 1 installed therein, with this figure also being used to discuss the system;

FIG. 5 is a chart that illustrates some of the functions of the traffic signal preemption system of the previous figures;

FIG. 6 is another chart that illustrates some of the functions of the traffic signal preemption system of the previous figures; and

FIG. 7 is yet another chart that illustrates some of the functions of the traffic signal preemption system of the previous figures.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION OF THE INVENTION

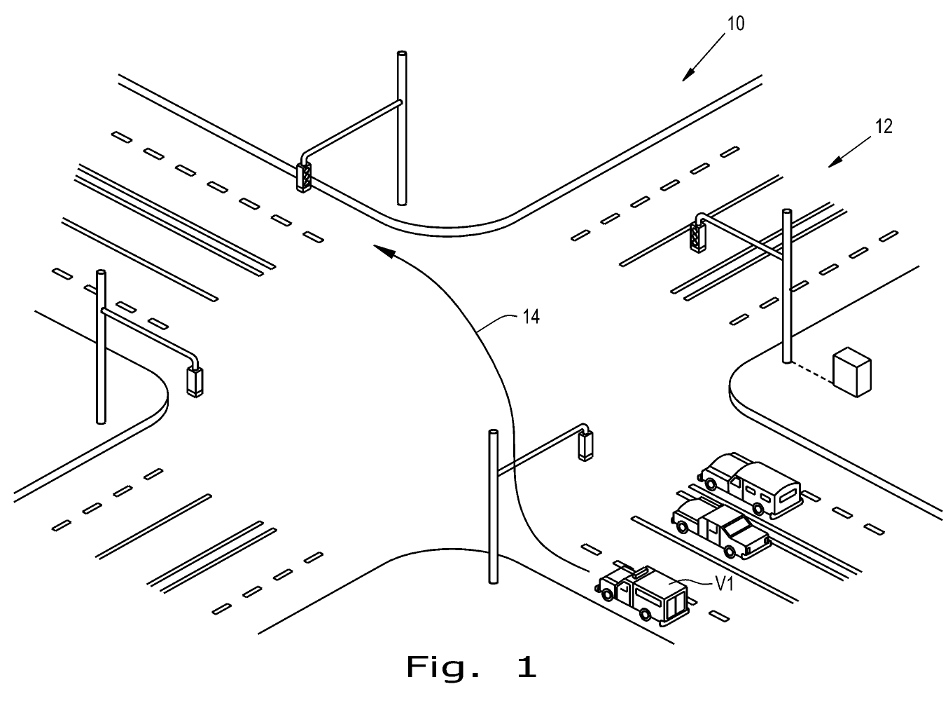

Referring now to the drawings, and in particular to FIG. 1 there is shown a traffic intersection with a traffic light system 10 under the control of a traffic light preemption system 12 of the present invention. An emergency vehicle V1 is shown moving in direction 14 with the light system 10 stopping the normal flow of traffic so that vehicle V1 can proceed through the intersection with no, or at least minimalized traffic. The present invention identifies the type of vehicle, the vehicle itself and/or the driver of the vehicle and uses this information to predict the travel path of vehicle V1 toward a destination. The prediction is based on historical travel information of the type of the vehicle, the vehicle itself and/or the identified driver.

The present invention puts forward the concept of “intelligent predictive preemption”, based on historical data. For the purposes of this invention, the term “preemption” can also mean transit signal priority for buses (TSP). The invention further allows the incorporation of geowindows, which are well known to those skilled in the discipline of traffic signal preemption and TSP (geowindows are disclosed in U.S. Pat. Nos. 5,986,575 and 8,912,922 among others). Geowindows may be created either by the intersection (as in U.S. Pat. No. 5,986,575), or by the vehicle (as in U.S. Pat. No. 8,912,922).

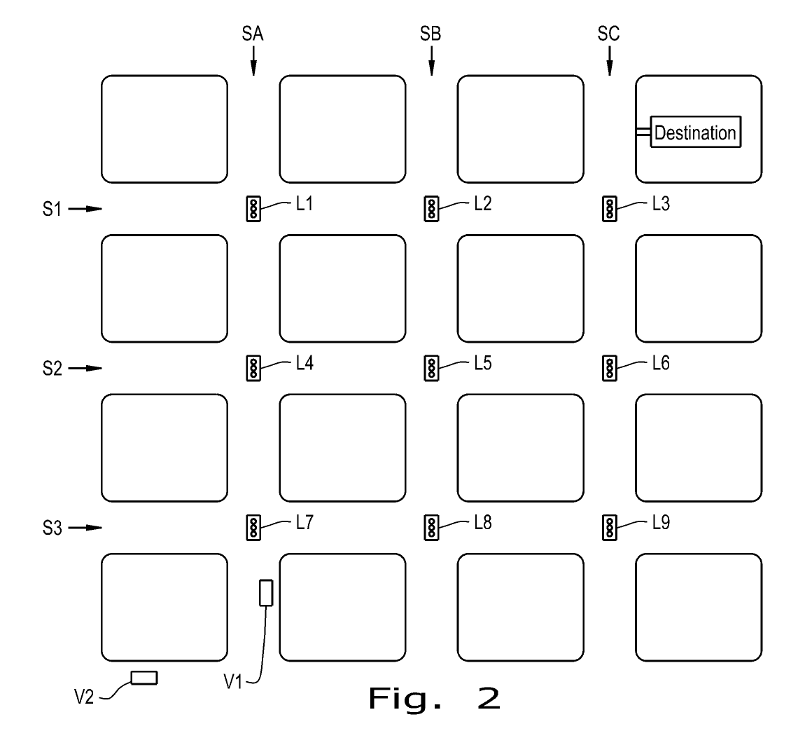

Now, additionally referring to FIG. 2 there is shown a generic grid of streets SA-SC and S1-S3, with a destination indicated. The present invention, when activated, receives information about the movement of vehicle V1 (by way of position detecting devices and active communication from vehicle V1) and preempts the operation of signal lights L1-L9 based on historical travel information. For ease of explanation we will assume that the destination is a hospital and vehicle V1 is an ambulance. As a first example we will discuss a scenario where only the type of vehicle is known and vehicle V1 has been identified as an ambulance. The historical travel patterns of ambulances shows that 80% of ambulances travel along street SA to light L1, turns right on street S1, then left on street SC at light L3 to arrive at the hospital. In this example, lights, L7, L4 and L1-L3 will be used, in a timed manner, to clear traffic so that vehicle V1 will have a statistically improved travel time to the hospital. It is also contemplated that lights L5, L6, L8 and L9 may be operated to move traffic away from the anticipated route.

Now, as a second example, we will assume that vehicle V1 has been identified as specifically No. 3 ambulance of the hospital. The historical travel pattern of No. 3 is that 75% of the time it takes street SA to street S2, turns right and continues on street S2 to street SC, turns left and proceeds straight to the hospital. In this case lights L7, L4, L5, L6 and L3 are used to preempt the normal working of these lights so that vehicle V1 can reach the destination in a statistically improved amount of time.

Now, as a third example, we will assume that vehicle V1 is being driven by an identified driver, here assumed to be Sally. Sally, as recorded in the historical travel database, 90% of the time turns right at light L7, proceeds along street S3 to light L9, turns left on street SC and then travels straight to the hospital. In this case lights L7-L9, L6 and L3 are used to preempt the normal working of these lights so that vehicle V1 can reach the destination in a statistically improved amount of time.

In the above scenarios if the driver uses a turn signal that is contrary to the predicted route, then the present invention responds to the turn signal selection to preempt traffic in that indicated route, and will release those lights from preemption which will now not be effected. For example if the No. 3 ambulance uses a turn signal to turn right at light L7, then the route along street S2 will be abandoned to normal operation and if a new likely route is predicted that route will anticipate the travel of No. 3.

In the above scenarios, if Sally were to use the left turn signal at light L7, and turn left on street S3 then the prediction to the hospital is abandoned, unless reestablished by some routing of vehicle V1 back toward the hospital. Here if Sally turns left at light L7 it may be predictive of a route to another hospital and the present invention adapts and establishes a predicted route thereto, using the preemption method of the present invention.

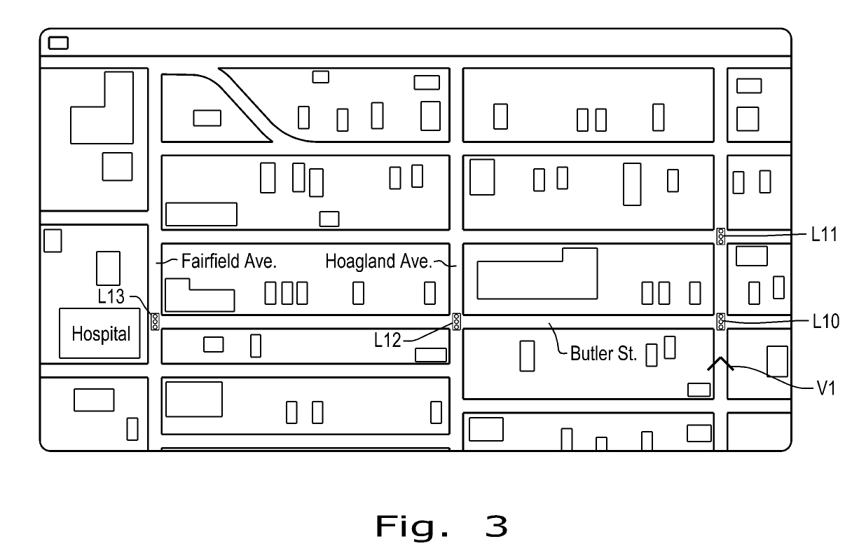

To illustrate the advantage of the present invention it is important to understand the difference between the prior art and the inventive nature of the present invention, look now to FIG. 3, which depicts an ambulance traveling in a direction that is upward on the figure (assumed to be northbound) on a street. As would be expected, in prior art systems the next two traffic signals L10 and L11 in its northbound path have already been preempted in its favor. If the ambulance is going to make a left turn onto Butler Street enroute to the hospital, some preemption systems have the ability to read the turn signal status of the vehicle and begin preempting the traffic lights L12 and L13 at Butler and Hoagland Ave, and Butler and Fairfield Ave in its favor. However, if the driver of the ambulance has forgotten to engage his left turn signal, the status of the other two traffic lights on Butler traveling west toward the hospital will remain in normal operation until after the driver has turned left onto Butler. Upon turning left onto Butler, the two traffic signals L12 and L13 at Butler and Hoagland, and Butler and Fairfield will begin preemption sequences. It is commonly known in the field of traffic signal preemption that preemption requests are not always granted immediately. Many require a preemption “preamble” that must allow for minimum clearance times for pedestrians in opposing directions, and for minimum green time in opposing directions. This may prevent the remaining traffic signals enroute to the hospital on Butler from promptly clearing the intersections along the ambulance's path, and can lead to unnecessary delays.

This problem is overcome by the approach of the present invention. For example, if an ambulance normally turns left at a given intersection 90% of the time, and the driver has forgotten to engage his left turn signal, this system will automatically begin a preemption sequence for traffic lights to the left of the intersection, just in case he does turn left, based on historical preemption data. This approach involves the storage of preemption data (including how many times the vehicle has previously turned left/right or continued straight through the intersection), retrieval of this data (including vehicle ID, driver ID, direction of travel, speed, date and time of preemption initiation and termination for each event, direction of preemption, location of intersection), the aggregation of the data, its analysis, and the additional subsequent preemption of traffic signals in anticipation of the emergency vehicle's path based on an analysis of this historical data is logged, aggregated, analyzed and put in useful form for administrative personnel to review. The logs and data generated by this methodology may additionally, for example, be useful as a training tool to show how many times a particular emergency vehicle turned right or left, while failing to properly use turn signals prior to making those turns. This could allow supervisors to identify which drivers, if any, may be in need of additional safety training regarding the proper use of turn signals.

It is also contemplated that the preemption system can detect a sequence of vehicles, such as a convoy or a funeral procession, with the detection being a vehicle that is allowed a prolonged preemption with the system detecting and tracking an ending event to the convoy/procession, such as an ending vehicle that releases the intersection from the preemption process. For example, in FIG. 2 a vehicle V2 will be considered the ending vehicle and as vehicles V1 and V2 proceed in the same path the preemption process for the route is continued until being released by the movement of vehicle V2 through the particular intersection. It is also contemplated that this sort of preemption may be used without anticipating the movement of vehicle V1 through traffic using the wrong lanes of travel as shown in FIG. 1, where vehicle V1 is in what would be a normally oncoming traffic lane. It is further contemplated that the ending event can be simply the passage of a predetermined amount of time.

It is further contemplated that the traffic signal preemption of the present invention will also take into account the historical travel patterns relative to the time of day, the day of the week and other historical events, such as holidays and community events (such as sporting events). For example, if a driver typically takes one route in the morning to the destination and another in the afternoon to the destination, the present invention will weigh such behavior in the decision to preempt the normal function of the traffic systems accordingly. This advantageously allows the present invention to take advantage of the historical data that may be related to driving habits that may be based on otherwise uncontemplated routine occurrences. These uncontemplated occurrences may be simply the solar incidence in the morning along one route versus another route that causes the driver to take a certain route in the morning and a different route in the afternoon.

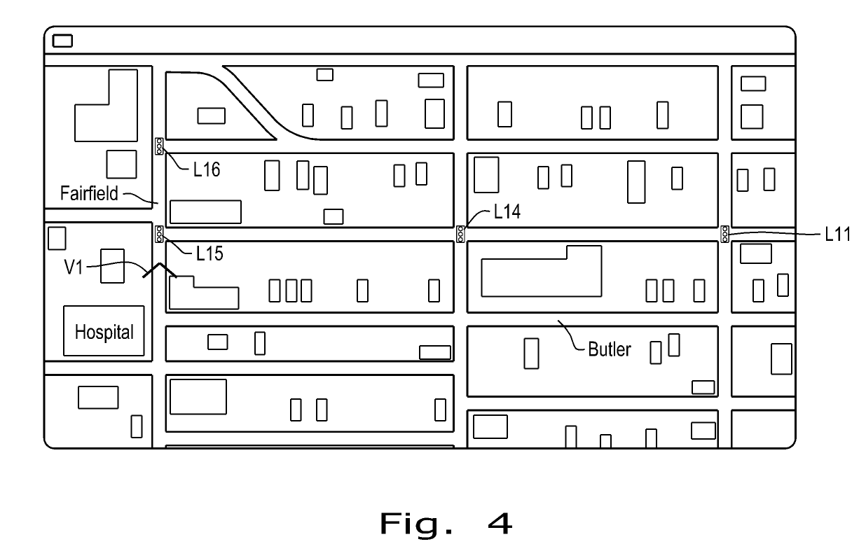

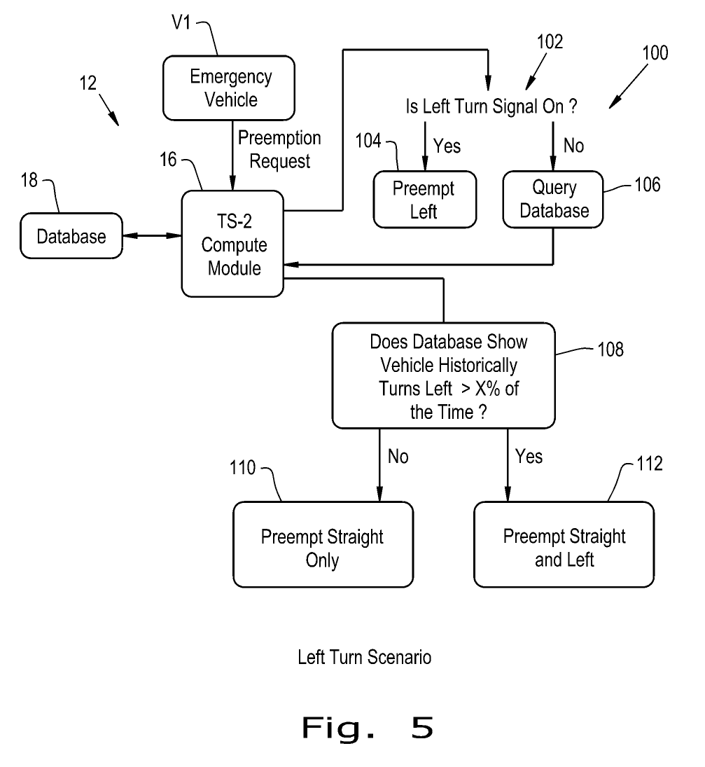

Now, additionally referring to FIG. 4 where lights L14-L16 are additionally identified, and to FIGS. 5-7 where combinations of function diagrams and flowcharts are used to further explain the operation of the present invention. In method 100 the logic behind a left turn is illustrated. Here vehicle V1 interacts with traffic preemption system 12 by making a preemption request to a traffic preemption device 16. Traffic preemption device 16 is in communication with a historical travel database 18, which stores historical travel patterns of vehicles that can request a traffic signal preemption from normal operations. At step 102 it is determined if the left turn signal is activated in vehicle V1, which can be in the form of a signal from a turn signal indicator or sensor, and if activated method 100 proceeds to step 104, otherwise method 100 proceeds to step 106.

At step 104 traffic preemption takes place dependent upon the use of a turn signal and method 100 continues to be available to assist in the preemption of a predicted pathway. Step 104 effectively overrides a contrary pathway prediction. However, if the left turn signal is in concert with the predicted path then the signal lights along that path are already in the mode of preempting their normal operation and the turn signal reinforces the already predicted travel path. As a result of arriving at step 104 lights L10, L12 and L13 will be preempted as vehicle V1 travels, see FIG. 3.

At step 106, database 18 is queried by device 16 to see what the identified type of vehicle, the identified specific vehicle and/or the driver of the vehicle generally does at upcoming intersections. At step 108 that follows, if vehicle V1 historically turns left at an intersection more than a predetermined percentage of the time then method 100 proceeds to step 112 and if not then to step 110. The method then repeats.

At step 110, if vehicle V1 is as shown in FIG. 3 then lights L10 and L11 are selected for preemption, since the historically left turn percentage is below the predetermined amount. Of course if vehicle V1 turns left then system 12 seeks to determine a new predicted pathway.

At step 112, lights L10-L13 are all selected for preemption since there is a reasonably high probability that vehicle V1 will turn left. The preemption of both the straight forward direction as well as the left turn is to accommodate the two likely travel paths of vehicle V1.

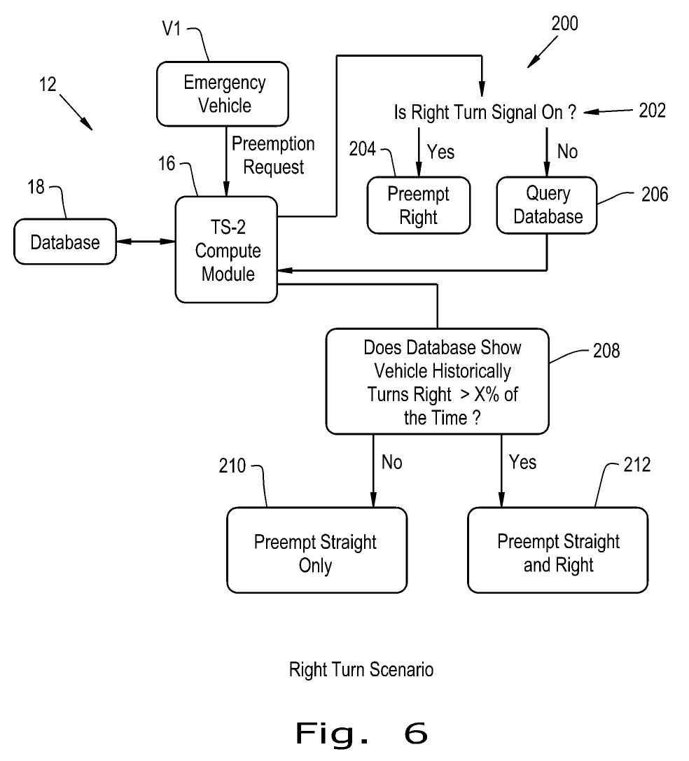

Now, reviewing a method 200, illustrated in FIG. 6, which is similar to the steps of method 100, with 100 added to the similar step numbers, and what is generally stated about method 100 is true of method 200 with the direction being addressed being right instead of left. The actions of vehicle V1 will be discussed relative to FIG. 4 as vehicle V1 is traveling on Fairfield.

At step 202 it is determined if the right turn signal is activated in vehicle V1, which can be in the form of a signal from a turn signal indicator or sensor, and if activated method 200 proceeds to step 204, otherwise method 200 proceeds to step 206.

At step 204 traffic preemption takes place dependent upon the use of a turn signal and method 200 continues to be available to assist in the preemption of a predicted pathway. Step 204 effectively overrides a contrary pathway prediction. However, if the right turn signal is in concert with the predicted path then the signal lights along that path are already in the mode of preempting their normal operation and the turn signal reinforces the already predicted travel path. As a result of arriving at step 204 lights L15, L14 and L11 will be preempted as vehicle V1 travels right at the next intersection, see FIG. 4.

At step 206, database 18 is queried by device 16 to see what the identified type of vehicle, the identified specific vehicle and/or the driver of the vehicle generally does at upcoming intersections. At step 208 that follows, if vehicle V1 historically turns right at an intersection more than a predetermined percentage of the time then method 200 proceeds to step 212 and if not then to step 210. The method then repeats.

At step 210, if vehicle V1 is as shown in FIG. 4 then lights L15 and L16 are selected for preemption, since the historically right turn percentage is below the predetermined amount. Of course if vehicle V1 turns right then system 12 seeks to determine a new predicted pathway.

At step 212, lights L15, L16, L 14 and L11 are all selected for preemption since there is a reasonably high probability that vehicle V1 will turn right. The preemption of both the straight forward direction as well as the right turn is to accommodate the two likely travel paths of vehicle V1 in this scenario.

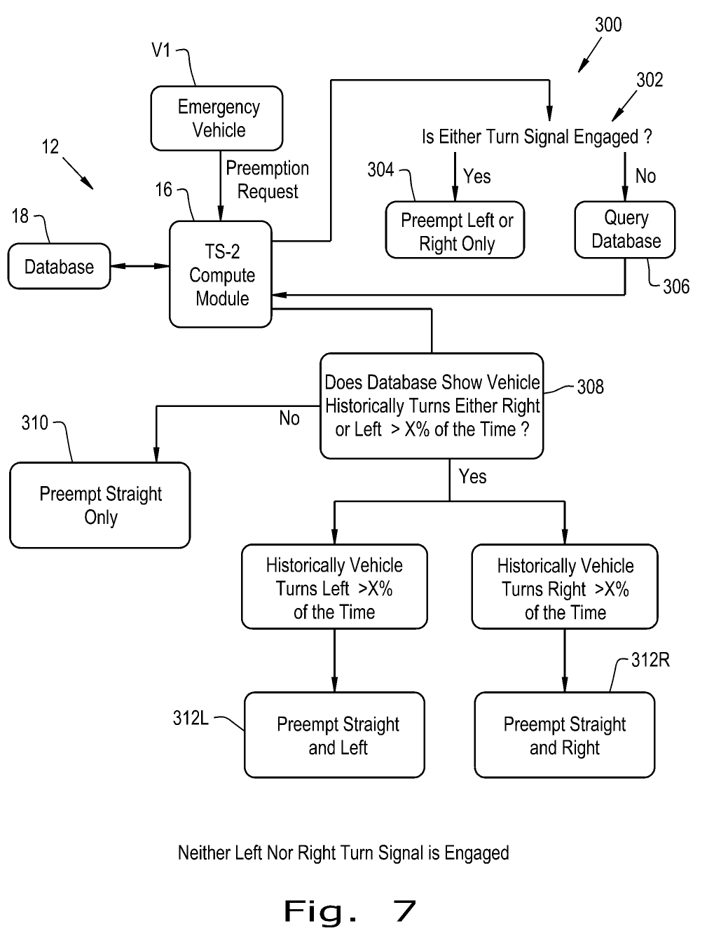

Now, reviewing a method 300, illustrated in FIG. 7, as a combining of methods 100 and 200, which is similar to the steps of both method 100 and 200, with a multiple of 100 added to the similar step numbers, and what is generally stated about methods 100 and 200 is true of method 300 with the direction being addressed being both right and left as well as no turn. The actions of vehicle V1 will be discussed relative to FIGS. 3 and 4 as previously discussed relative to methods 100 and 200.

At step 302 it is determined if either the right or left turn signal is activated in vehicle V1, which can be in the form of a signal from a turn signal indicator or sensor, and if activated method 300 proceeds to step 304, otherwise method 300 proceeds to step 306.

At step 304 traffic preemption takes place dependent upon the use of the turn signal and method 300 continues to be available to assist in the preemption of a predicted pathway. Step 304 effectively overrides a contrary pathway prediction. However, if the turn signal is in concert with the predicted path then the signal lights along that path are already in the mode of preempting their normal operation and the turn signal reinforces the already predicted travel path. As a result of arriving at step 304 lights in the selected direction will be preempted as vehicle V1 travels right at the next intersection, see FIG. 4, or left at the next intersection, see FIG. 3, as applicable.

At step 306, database 18 is queried by device 16 to see what the identified type of vehicle, the identified specific vehicle and/or the driver of the vehicle generally does at upcoming intersections. At step 308 that follows, if vehicle V1 historically turns at an upcoming intersection more than a predetermined percentage of the time then method 300 proceeds to the appropriate step 312L or 312R and if not then to step 310. The method then repeats.

At step 310, vehicle V1 is presumed to be heading in a straight direction and the lights in the straight direction are selected for preemption, since the historically right or left turn percentages are below the predetermined amount. Of course if vehicle V1 turns at the upcoming intersection then system 12 seeks to determine a new predicted pathway.

At step 312L, lights to the left as well as those in a straight path are all selected for preemption since there is a reasonably high probability that vehicle V1 will turn left. The preemption of both the straight forward direction as well as the left turn is to accommodate the two likely travel paths of vehicle V1 in this scenario.

At step 312R, lights to the right as well as those in a straight path are all selected for preemption since there is a reasonably high probability that vehicle V1 will turn right, in spite of the lack of use of the turn signal. The preemption of both the straight forward direction as well as the right turn is to accommodate the two likely travel paths of vehicle V1 in this scenario.

While a system for directional control and the flow of traffic has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A traffic preemption system, comprising:
at least one identification device for identification of a vehicle and/or a driver;
a historical travel database including records of routes previously taken by the vehicle or the driver; and
a traffic signal preemption device preempting a normal action of traffic signals dependent upon the vehicle and/or the driver identified by the identification device and the routes previously taken by the vehicle and/or the driver as determined by the historical travel database.

2. The traffic preemption system of claim 1, wherein the identification device identifies the vehicle.

3. The traffic preemption system of claim 2, wherein the identification device identifies a type of the vehicle.

4. The traffic preemption system of claim 3, wherein the historical travel database includes travel data related to the type of the vehicle.

5. The traffic preemption system of claim 3, wherein dependent upon the type of vehicle identified by the identification device the traffic signal preemption device is configured to continue to preempt the normal action of traffic signals until an end of preemption event is detected.

6. The traffic preemption system of claim 5, wherein the end of preemption event is a detection of an ending vehicle.

7. The traffic preemption system of claim 1, wherein the identification device identifies the driver of the vehicle.

8. The traffic preemption system of claim 1, further comprising a turn signal detector for the vehicle configured to provide a turn signal indication signal to the traffic signal preemption device for preempting the normal action of traffic signals dependent upon the turn signal indication signal.

9. The traffic preemption system of claim 8, wherein the turn signal indication signal causes the traffic signal preemption device to not use the historical travel database.

10. The traffic preemption system of claim 1, wherein the historical travel database includes both historical travel data when the vehicle is using the traffic preemption system and when the vehicle is not using the traffic preemption system.

11. A method of preempting traffic signals, comprising the steps of:
identifying at least one of a vehicle and an operator of the vehicle;
comparing a current route of at least one of the identified vehicle and the identified operator with previous travel routes of the at least one of the identified vehicle and the identified operator;
predicting at least one likely travel path of the vehicle dependent upon the results of the comparing step; and
preempting a normal operation of traffic signals along the at least one likely travel path of the vehicle.

12. The method of claim 11, wherein the identifying step identifies the vehicle.

13. The method of claim 12, wherein the identifying step identifies a type of the vehicle.

14. The method of claim 13, wherein the previous travel routes are contained in a historical travel database that includes travel data related to the type of the vehicle.

15. The method of claim 13, wherein dependent upon the type of vehicle identified in the identifying step the preempting step additionally includes the step of continuing to preempt the normal action of traffic signals until an end of preemption event is detected.

16. The method of claim 15, wherein the end of preemption event is a detection of an ending vehicle.

17. The method of claim 11, wherein the identifying step identifies the driver of the vehicle.

18. The method of claim 11, further comprising a turn signal detector for the vehicle configured to provide a turn signal indication signal, with the preempting step preempting the normal action of traffic signals dependent upon the turn signal indication signal.

19. The method of claim 18, wherein the turn signal indication signal causes the method to not use the likely travel path.

20. The method of claim 11, wherein the previous travel routes are contained in a historical travel database, the historical travel database includes both historical travel data when the vehicle is using the method and when the vehicle is not using the method.
